(19) United States
(12) Patent Application Publication
(10) Pub. No.: US 2020/0249996 A1
(43) Pub. Date: Aug. 6, 2020

(54) SYSTEMS AND METHODS FOR ARTIFICIAL INTELLIGENCE HARDWARE PROCESSING

(71) Applicant: Pathtronic Inc., San Francisco, CA (US)

(72) Inventors: Sateesh Kumar Addepalli, San Jose, CA (US); Vinayaka Jyothi, Sunnyvale, CA (US); Ashik Hoovayya Poojari, Sunnyvale, CA (US)

(21) Appl. No.: 16/528,543

(22) Filed: Jul. 31, 2019

Related U.S. Application Data
(60) Provisional application No. 62/801,046, filed on Feb. 4, 2019.

(51) Int. Cl. G06F 9/50; G06F 9/30; G06F 9/38; G06N 3/04; G06N 20/10; G06F 9/54

(52) U.S. Cl. CPC G06F 9/5016; G06F 9/30101; G06F 9/544; G06N 3/0418; G06N 20/10; G06F 9/3877

(57) ABSTRACT

An artificial intelligence (AI) system is disclosed. The AI system provides an energy efficient hyper parallel and pipelined temporal and spatial scalable secure AI hardware with minimized external memory access. One or more than one re-configurable AI compute engine blocks may be interconnected via one or more high speed interconnect busses to enable an AI processing chain and data exchange between themselves. A hardware sequencer is disclosed to enable an AI processing chain execution driven by dynamically composed AI processing chains.

### CROSS REFERENCES TO RELATED APPLICATIONS

This application claims priority to U.S. Provisional Application No. 62/801,046, filed, Feb. 4, 2019, and titled, “SYSTEMS AND METHODS FOR ARTIFICIAL INTELLIGENCE HARDWARE PROCESSING,” the disclosure of which is hereby incorporated herein in its entirety and for all purposes.

### TECHNICAL FIELD

The subject matter disclosed herein generally relates to artificial intelligence (AI). More specifically, the present disclosures relate to methods and systems for AI hardware processing.

### BACKGROUND

Today, AI solutions and/or AI models (which may be referred to collectively herein as AI solution models) have been pre-trained and then deployed in a wide range of applications (e.g., cloud/edge, connected/autonomous vehicles, industrial IoT (Internet of Things), health and wellness, smart cities/spaces, etc.). The AI solution model may be an output of an AI system that solves a problem or a request made by a user. For example, an AI solution model may be the output by the AI system based on the user having requested of the AI system to generate a model that, when performed by the AI system, organizes images into various categories after being trained on a set of training data. It would be desirable to provide AI applications and/or AI solution models integrated into a secure AI hardware system with integrated security without intervention of a central processing unit (CPU), graphics processing unit (GPU) , software framework, or operating system (OS) dependency or any combination thereof.

Conventional AI implementations employ GPUs that run on threads which are controlled and coordinated by software rather than hardware such as state machines. GPUs use floating point hardware calculations rather than fixed point hardware for computations, consequently GPUs use more latency and more energy to calculate an output relative to fixed point hardware computations. Fixed point functional units require less hardware for performing computations and hence more hardware on the integrated circuit can be allocated for other functions when compared to GPUs with the same number of resources.

Conventional GPUs run on addition and multiplication level of granularity, where each will run a number of threads that compete for GPU resources to finish. Hence it takes more time and energy to complete a computation.

Conventional GPU hardware is based on a general purpose single instruction multiple data (SIMD) architecture. In this environment, all the algorithms are controlled by the software code. Hence the output computation waits for the microcode to execute and takes more machine cycles to complete a computation.

Conventional GPUs do not contain a security engine to check for the integrity of the executing software programs such as hashing, encryption/decryption and pattern matching hardware. Thus, conventional GPUs do not provide security measures to fight different types of attacks. A GPU hides its memory latency by executing a large number of threads at the same time. Hence after the execution of each thread is available to occupy compute block. So efficiency of the hardware is good when executing the same layer for more no of inputs. Consequently they employ batch processing and real time processing is not possible.

### BRIEF DESCRIPTION OF THE DRAWINGS

Various aspects embodiments are illustrated by way of example and not limitation in the figures of the accompanying drawings.

FIG. 1 is a diagram of an artificial intelligence (AI) system lane comprising energy efficient hyper parallel and pipelined temporal and spatial scalable AI hardware with minimized external memory access, in accordance with at least one aspect of the present disclosure.

FIG. 2 is a diagram of a secure re-configurable AI compute engine block with no traditional software overhead during model execution (inference or training) for speed and efficiency, in accordance with at least one aspect of the present disclosure.

FIG. 3 is a diagram showing an example of how AI-PLUs may be configured to perform back propagation, according to at least one aspect of the present disclosure.

FIG. 4 is a diagram of an AI system processing logic unit (AI-PLU) instance within a convolutional neural network (CNN) AI processing block/engine for forward/backward propagation, in accordance with at least one aspect of the present disclosure.

FIG. 5 is a diagram of an AI-PLU instance within a max-pooling AI processing block/engine for forward/backward propagation, in accordance with at least one aspect of the present disclosure.

FIG. 6 is a diagram of an AI-PLU instance within an un-pooling AI processing block/engine for back propagation, in accordance with at least one aspect of the present disclosure.

FIG. 7 is a diagram of an AI-PLU instance within a fully connected-recurrent neural network (FC-RNN) AI processing block/engine for forward/backward propagation, in accordance with at least one aspect of the present disclosure.

FIG. 8 is a diagram of an AI-PLU instance within a machine learning classification processing block, in accordance with at least one aspect of the present disclosure.

FIG. 9 is a diagram of an AI-PLU instance within a sort processing block, in accordance with at least one aspect of the present disclosure.

FIG. 10A is a diagram of an AI system security processing logic unit (S-PLU) instance for cryptography—PKI encryption/decryption, in accordance with at least one aspect of the present disclosure.

FIG. 10B is a zoomed in view showing functional block diagrams of an encrypt/decrypt block used in the S-PLU cryptography unit in FIG. 10A, according to some aspects.

FIG. 11 is a diagram of an AI S-PLU instance for cryptography—hash function, in accordance with at least one aspect of the present disclosure.

FIG. 12A is a diagram of an AI S-PLU instance for pattern matching, in accordance with at least one aspect of the present disclosure.

FIG. 12B is a zoomed in view of the NFA/DFA block that is used in the AI S-PLU instance for pattern matching in FIG. 12A, according to at least one aspect of the present disclosure.

FIG. 13 is a diagram of an adaptive intelligent processing logic unit (ADI-PLU) comprising a collection of intelligent sense neuro memory cell units (ISN MCUs), in accordance with at least one aspect of the present disclosure.

### DETAILED DESCRIPTION

Applicant of the present application owns the following U.S. Provisional Patent Applications, contemporaneously filed on Feb. 4, 2019, the disclosure of each of which is herein incorporated by reference in its entirety:
U.S. Provisional Application No. 62/801,044, titled SYSTEMS AND METHODS OF SECURITY FOR TRUSTED AI HARDWARE PROCESSING;
U.S. Provisional Application No. 62/801,048, titled SYSTEMS AND METHODS FOR ARTIFICIAL INTELLIGENCE WITH A FLEXIBLE HARDWARE PROCESSING FRAMEWORK;
U.S. Provisional Application No. 62/801,049, titled SYSTEMS AND METHODS FOR CONTINUOUS AND REAL-TIME AI ADAPTIVE SENSE LEARNING;
U.S. Provisional Application No. 62/801,050, titled LIGHTWEIGHT, HIGH SPEED AND ENERGY EFFICIENT ASYNCHRONOUS AND FILE SYSTEM-BASED AI PROCESSING INTERFACE FRAMEWORK; and
U.S. Provisional Application No. 62/801,051, titled SYSTEMS AND METHODS FOR POWER MANAGEMENT OF HARDWARE UTILIZING VIRTUAL MULTILANE ARCHITECTURE.

Applicant of the present application also owns the following U.S. Non-Provisional Patent Applications, filed herewith, the disclosure of each of which is herein incorporated by reference in its entirety:
Attorney Docket No. 1403394.00003, titled SYSTEMS AND METHODS OF SECURITY FOR TRUSTED AI HARDWARE PROCESSING;
Attorney Docket No. 1403394.00009, titled SYSTEMS AND METHODS FOR ARTIFICIAL INTELLIGENCE WITH A FLEXIBLE HARDWARE PROCESSING FRAMEWORK;
Attorney Docket No. 1403394.00012, titled SYSTEMS AND METHODS FOR CONTINUOUS AND REAL-TIME AI ADAPTIVE SENSE LEARNING;
Attorney Docket No. 1403394.00015, titled LIGHTWEIGHT, HIGH SPEED AND ENERGY EFFICIENT ASYNCHRONOUS AND FILE SYSTEM-BASED AI PROCESSING INTERFACE FRAMEWORK; and
Attorney Docket No. 1403394.00018, titled SYSTEMS AND METHODS FOR POWER MANAGEMENT OF HARDWARE UTILIZING VIRTUAL MULTILANE ARCHITECTURE.

Aspects of the present disclosure are presented for an AI system featuring specially designed AI hardware that incorporates security features to provide iron clad (e.g., robust) trust and security to run AI applications/solution models. The AI system may include one or more than one AI system lanes, one or more than one re-configurable secure AI compute engine block hardware circuit, one or more than one AI system processing logic unit (AI-PLU) for high speed wide width and parallel vector processing for extreme speed and efficiency, and one or more than one AI system security processing logic unit (S-PLU) for high speed wide width and parallel processing of security functions for extreme speed and efficiency. In one aspect, a trust mechanism may be integrated into the AI system lane. This feature would enable the AI system lane to communicate with a trust network to ascertain the trustability of a model, model owner, or model user or any combinations thereof. In one aspect, a user may provide a definition of AI processing and security through configuration.

In one aspect, an AI system lane provides an energy efficient hyper parallel and pipelined temporal and spatial scalable secure AI hardware with minimized external memory access. One or more than one re-configurable AI compute engine blocks may be interconnected via one or more high speed interconnect busses to enable an AI processing chain and data exchange between themselves. A hardware sequencer is provided to enable an AI processing chain execution driven by dynamically composed AI processing chains.

In one aspect, an AI system provides a re-configurable secure AI compute engine block hardware that does not employ traditional software overhead during AI solution model execution (inference or training) for speed and efficiency. One or more than one parallel AI processing sub-blocks may be connected to enable high speed processing non-blocking. A main AI processing state machine follows the parallel AI processing sub-blocks—RETRIEVE, COMPOSE, EXECUTE, TRANSFER—to run various blocks/sub-blocks. This way, different AI and security algorithms can run with re-configurability to allow flexibility through the AI application parametrization.

In one aspect, an AI system provides an AI-PLU for high speed wide width and parallel vector processing for extreme speed and efficiency. A generic AI-PLU is a special type of AI sub-block with one or more wide width (>512) multipliers, adders, comparators whose parallel and pipelined arrangement can be re-configured such that one or more sets can run parallel and results from one set to another transferred in a pipelined fashion with maximum performance and power efficiency. A re-configurable AI compute engine block may contain one or more AI PLUs. Based on various arrangements, an AI-PLU can take the shape of various AI-PLU instances, namely:

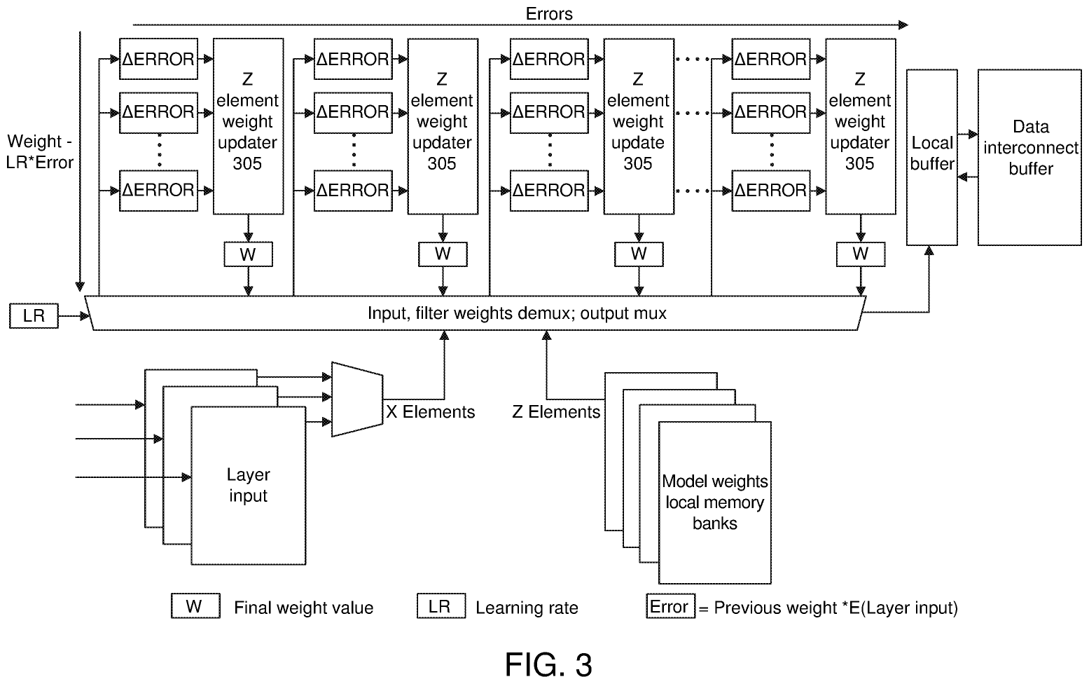

A. An AI system processing logic unit (AI-PLU) instance configured to perform back propagation with reference to FIG. 3.

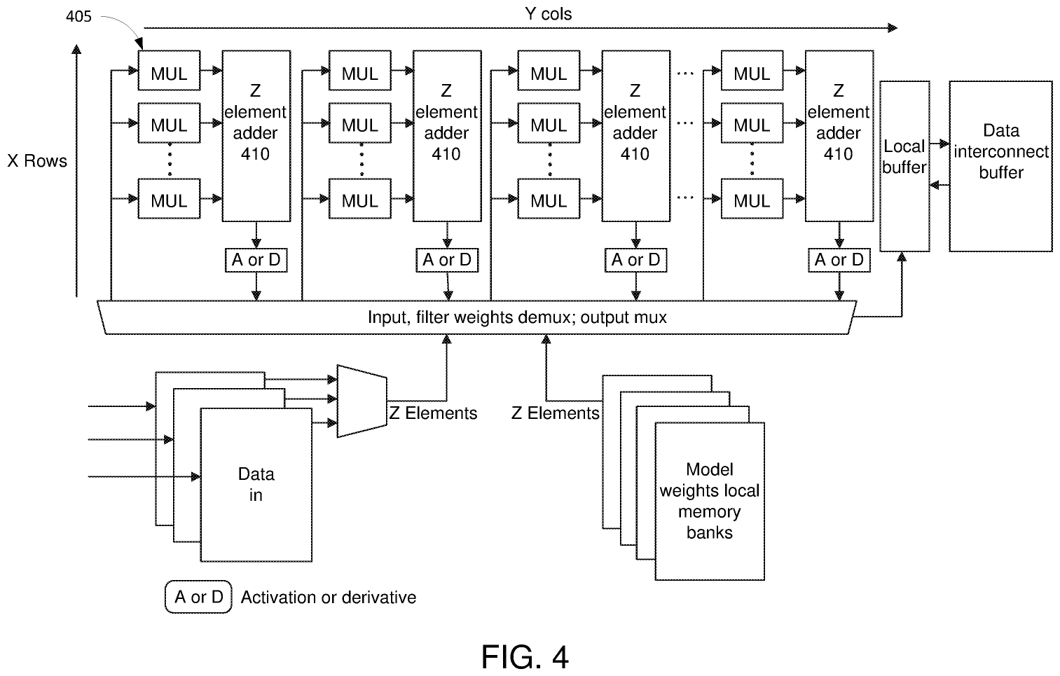

B. An AI-PLU instance within a convolutional neural network (CNN) AI processing block/engine for forward/backward propagation as described with reference to FIG. 4.

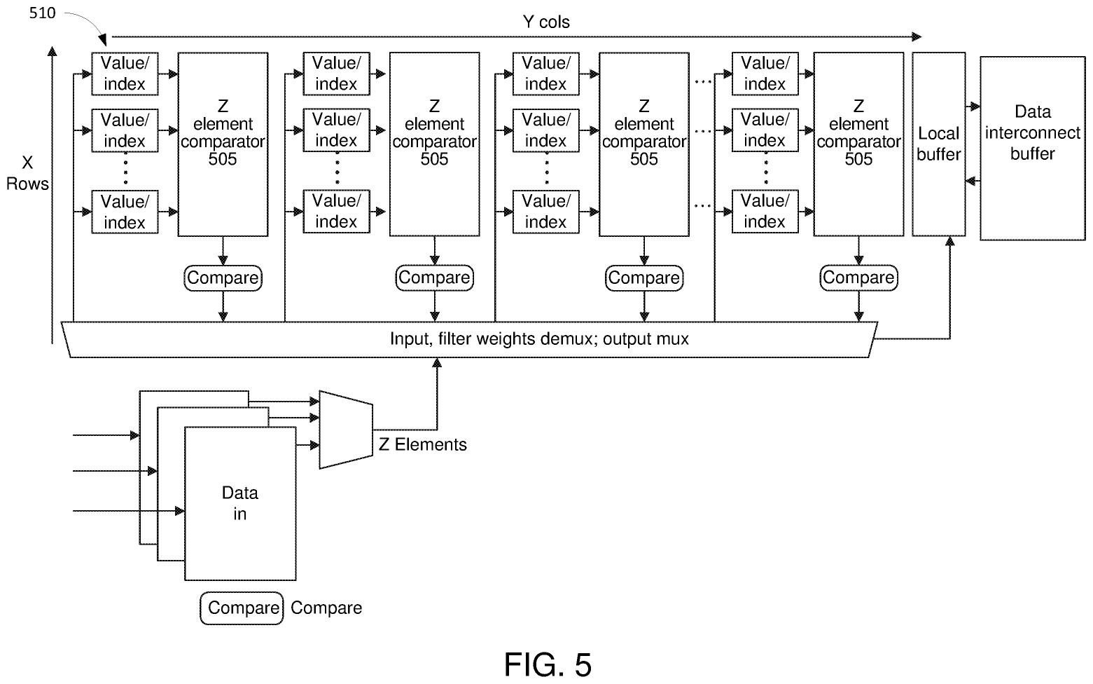

C. An AI-PLU instance within a max-pooling AI processing block/engine for forward/backward propagation as described with reference to FIG. 5.

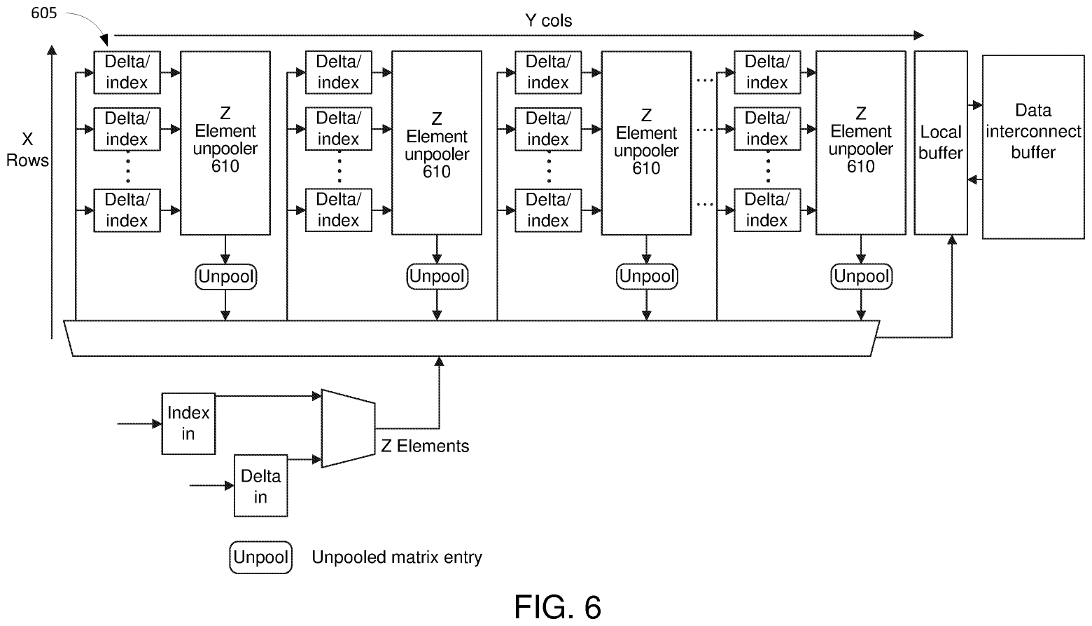

D. An AI-PLU instance within an un-pooling AI processing block/engine for back propagation as described with reference to FIG. 6.

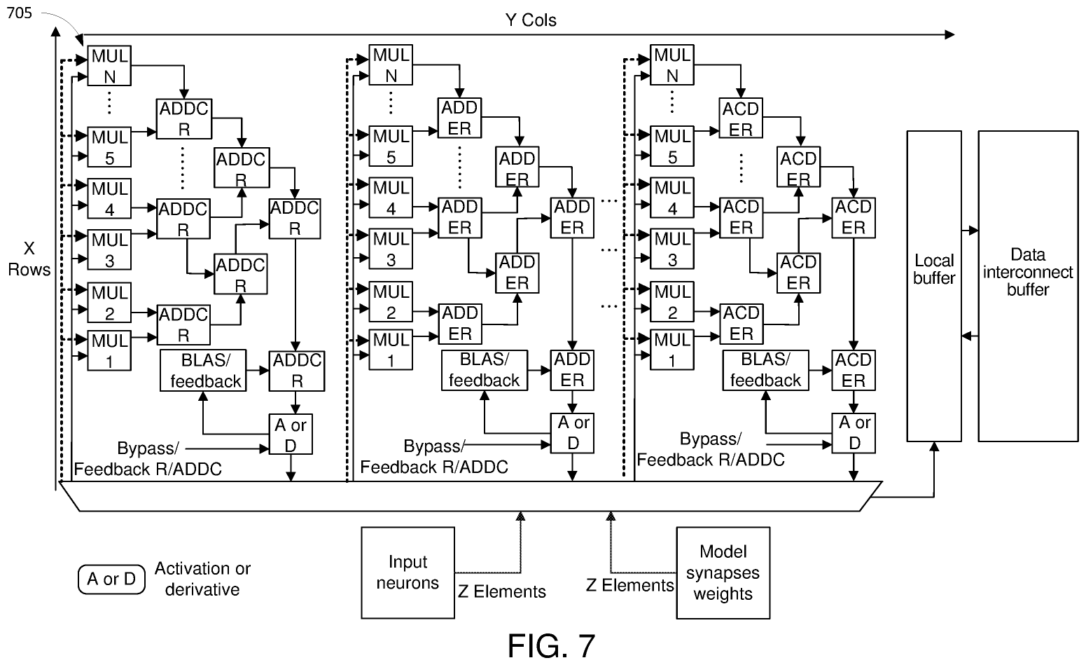

E. An AI-PLU instance within a FC-RNN (fully connected-recurrent neural network) AI processing block/engine for forward/backward propagation as described with reference to FIG. 7.

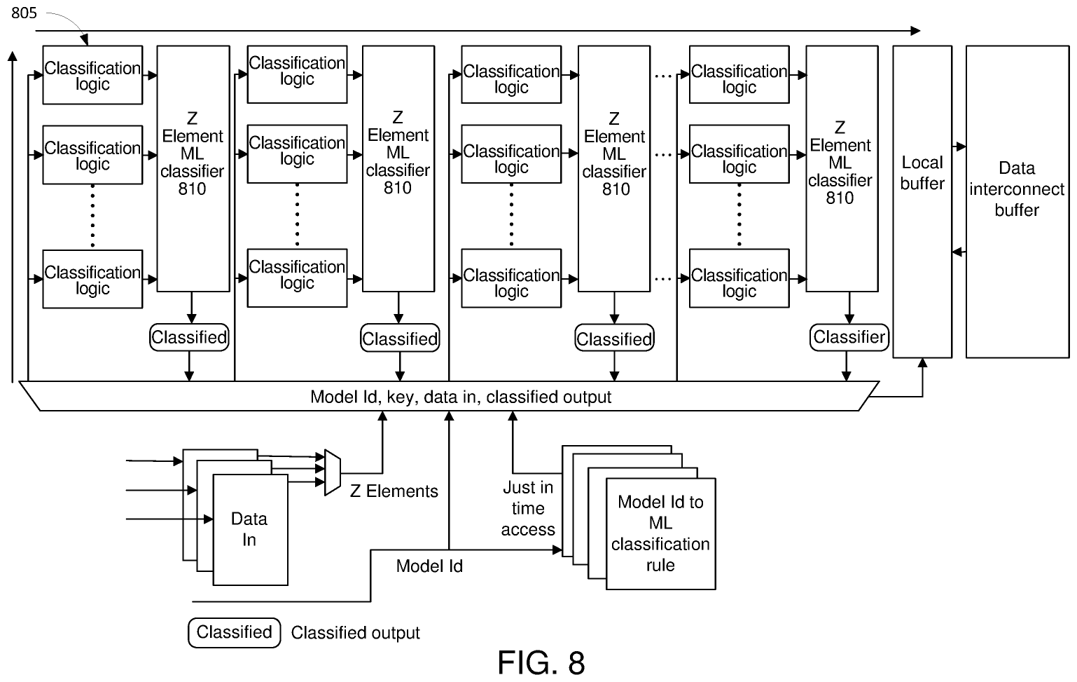

F. An AI-PLU instance within a machine learning classification processing block as described with reference to FIG. 8.

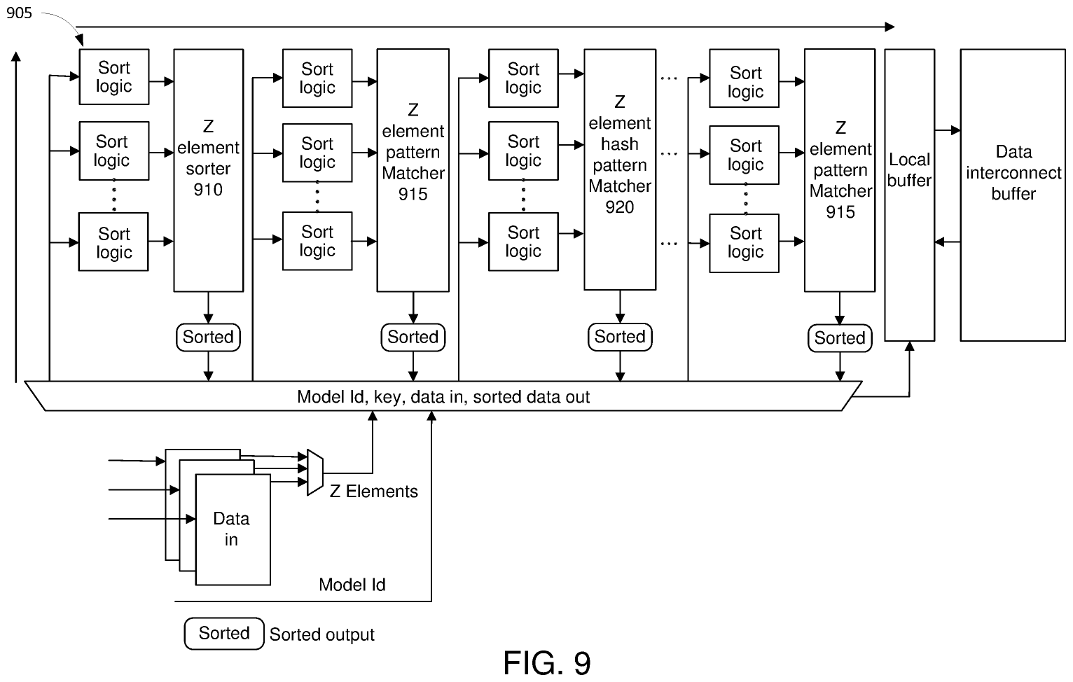

G. An AI-PLU instance within a sort processing block as described with reference to FIG. 9.

In one aspect, an AI system provides one or more than one AI system S-PLU for high speed wide width and parallel processing of security functions for extreme speed and efficiency. A generic S-PLU is a special type of sub-block with one or more wide width (>512 bits) hash/digest, encryption, decryption, nonce, and other foundation functions, whose parallel and pipelined arrangement can be re-configured such that one or more sets can run parallel and results from one set to another transferred in a pipelined fashion with maximum performance and power efficiency. A re-configurable AI compute engine block may contain one or more Security PLUs. Based on various arrangements, a S-PLU can take the shape of various S-PLU instances, namely:

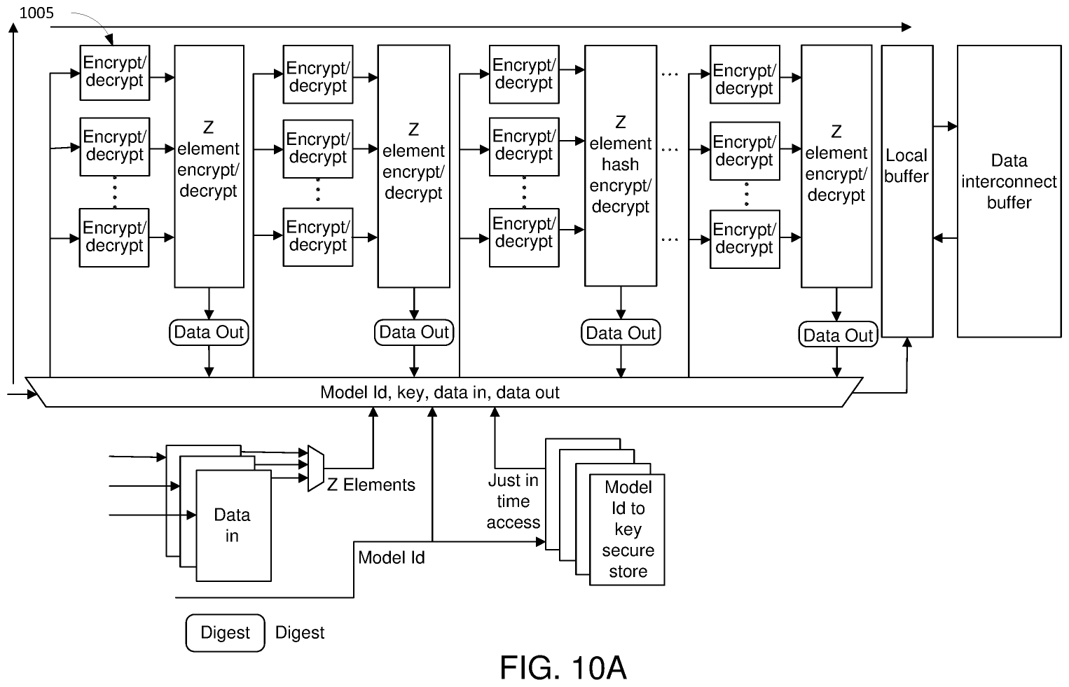

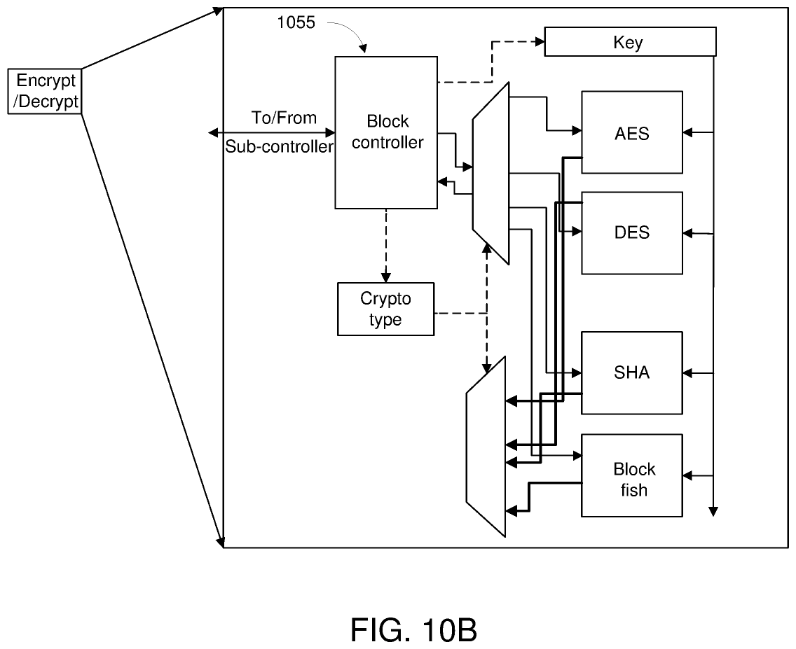

A. An AI S-PLU instance for cryptography—PKI encryption/decryption as described with reference to FIG. 10.

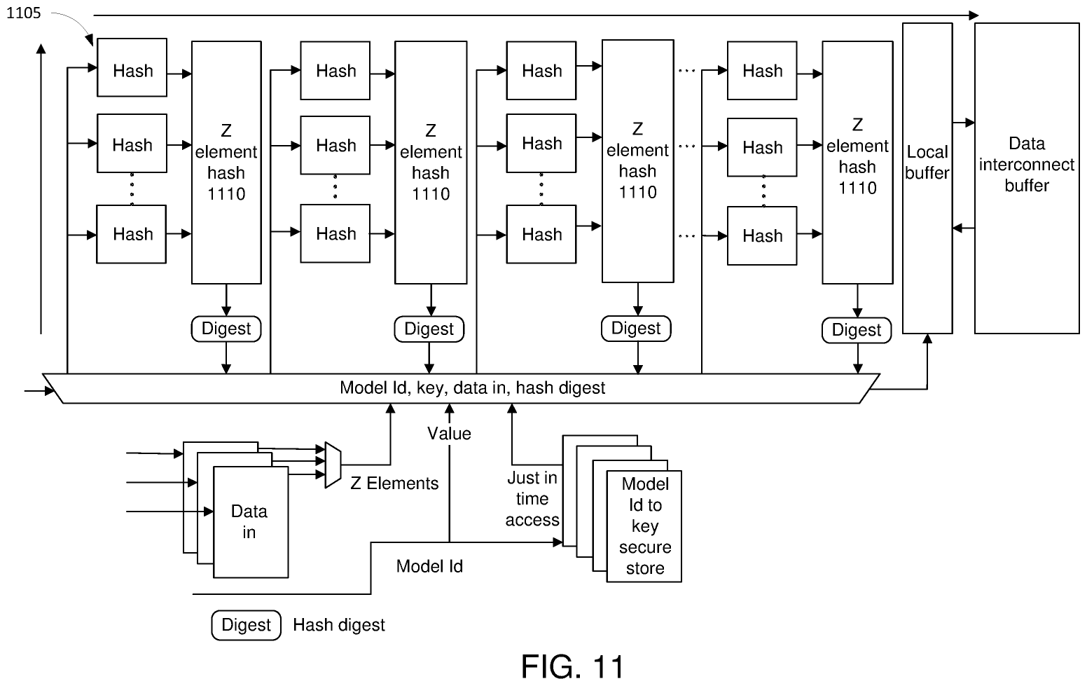

B. An AI S-PLU instance for cryptography—hash function as described with reference to FIG. 11.

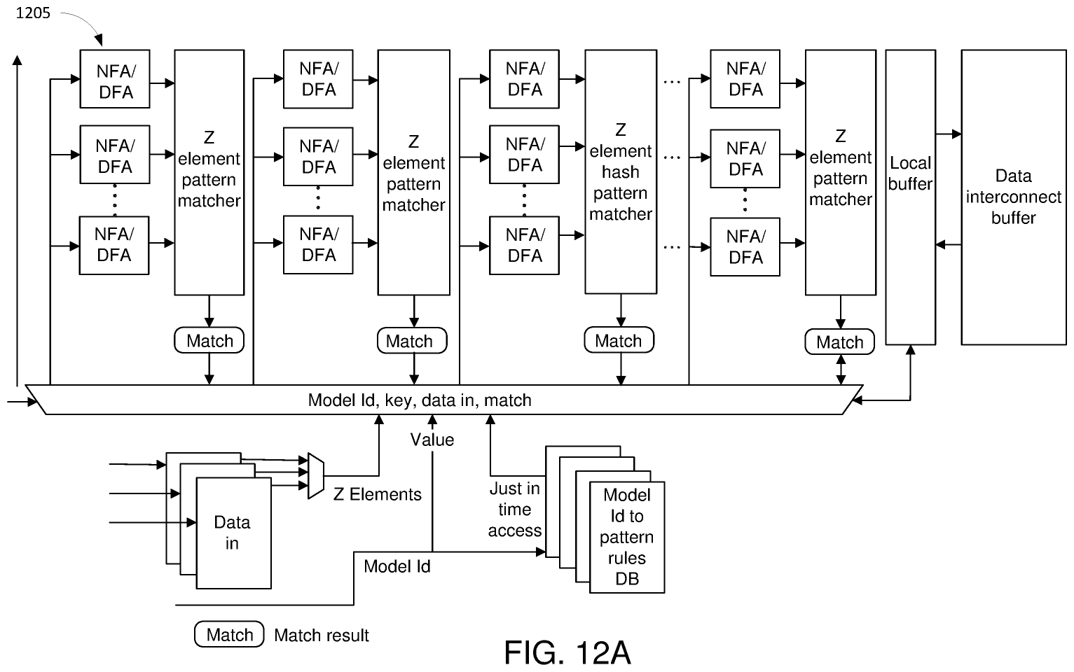

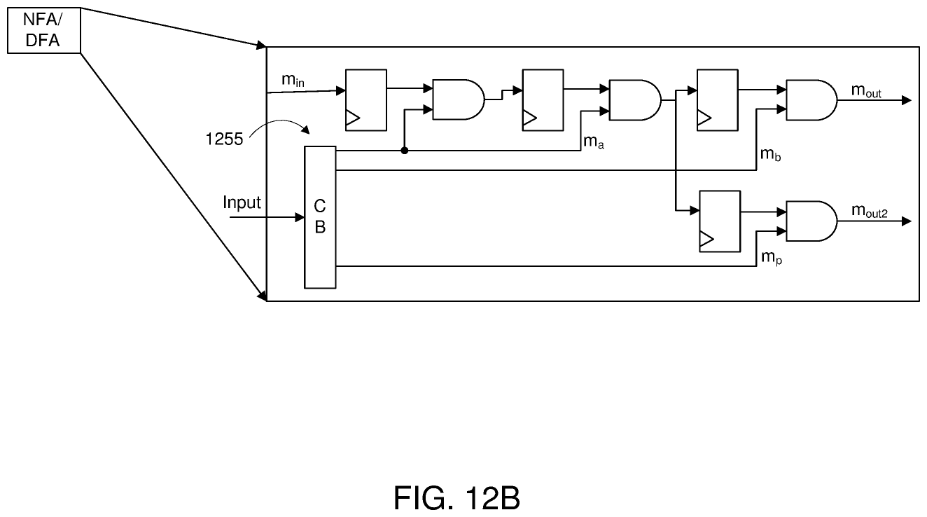

C. An AI S-PLU instance for pattern matching as described with reference to FIG. 12.

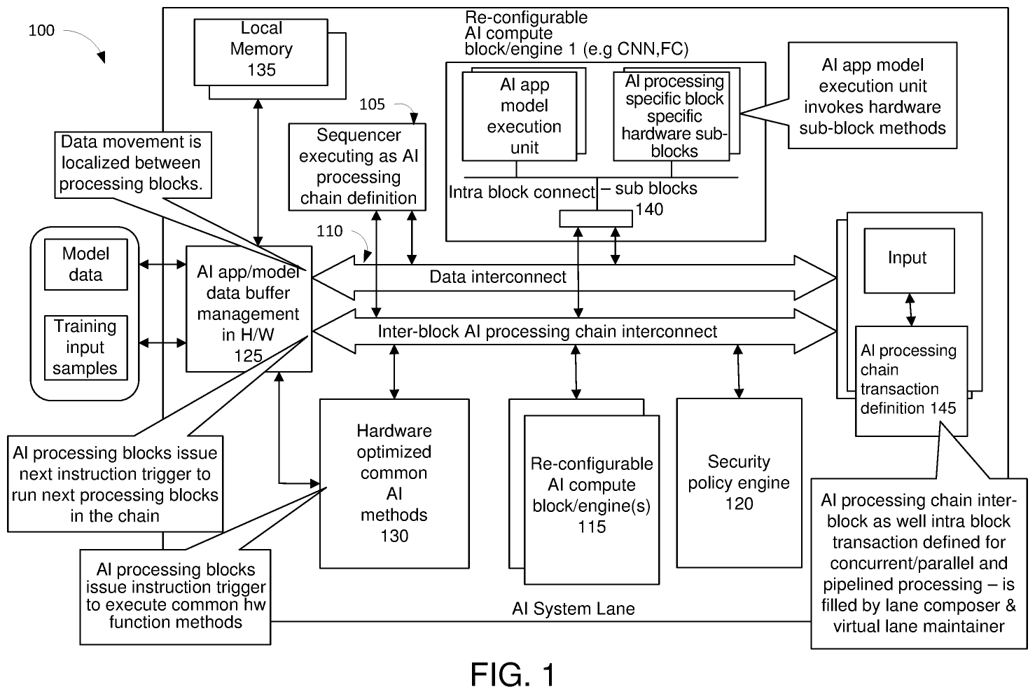

FIG. 1 is a diagram 100 of an AI system lane comprising energy efficient hyper parallel and pipelined temporal and spatial scalable artificial intelligence (AI) hardware with minimized external memory access, in accordance with at least one aspect of the present disclosure. An AI system lane is an integrated secure AI processing hardware framework with an amalgamation of hyper-parallel-pipelined (HPP) AI compute engines interlinked by data interconnect busses with a hardware sequencer 105 to oversee AI compute chain execution. The execution flow is orchestrated by the sequencer 105 by using an AI processing chain flow. The blocks within the AI system lane are interconnected by high bandwidth links, e.g., data interconnects 110 and inter-block AI processing chain interconnects, to transfer the output between each other. Therefore, one or more AI compute engines can run in parallel/pipeline to process the AI algorithm.

In various aspects, an AI system lane comprises eight major blocks, such as re-configurable AI compute engine blocks 115, interconnects 110, a sequencer 105, common method processing blocks 130, local memory 135, security policy engine block 120, AI application data management buffer 125, intra block connect sub blocks 140, etc. All the modules work together to solve the task assigned to the AI system lane.

In one aspect, the AI system lane comprises re-configurable AI compute engines/blocks hardware 115. The re-configurable AI compute engines/blocks hardware is an AI system integrated high performance and highly efficient engine. The re-configurable AI compute engines/blocks hardware computes the AI methods assigned by the sequencer 105. The sequencer 105 is comprised of a state machine with one or more configurable AI-PLUs to process the AI application/model. The sequencer 105 maintains a configurable AI-PLU to compute different type of methods. Due to the configurable nature of the hardware, utilization is very high. Hence, a high throughput is achieved at a low clock frequency and the process is very energy efficient. In case of secure processing, it also contains one or more S-PLUs to process security related features and consequently provide iron clad security to the AI system lane as well as enabling a wide range of AI driven security applications. The re-configurable AI compute engine blocks 115 eliminate the need for an operating system and AI software framework during the processing of AI functions.

In one aspect, the AI system lane comprises local memory 135. The local memory 135 may be a high speed memory interfaced to the AI application data management hardware 125. It has the data, the layer results, weights, and inputs required by the AI system lane to execute.

In one aspect, the AI system lane comprises a common method processing block 130. The common method processing block 130 contains the hardware to process common functions. For example, encrypting the output, etc.

In one aspect, the AI system lane comprises an AI application data management buffer block 125. The AI application data management buffer block manages the memory requirement between the blocks. It also maintains the data transfer between the global memory and local memory.

In one aspect, the AI system lane comprises data and AI processing chain interconnects 110. All the blocks are connected by the data interconnect bus and an inter-block AI processing chain interconnect bus. The data interconnect bus transfers data within the engines and transfers to local memory. The inter-block AI processing chain interconnect bus carries all the control information. Control blocks include, for example, application buffer management H/W, sequencer, and instruction trigger modules. Data movement is localized within the blocks. The data interconnect bus has higher bandwidth when compared to the inter-block AI processing chain interconnect.

In one aspect, the AI system lane comprises a security policy engine 120. The security policy engine safeguards the AI system lanes from security attacks (virus/worms, intrusions, denial of service (DoS), theft). The security policy engine directs enforcement of all the security features required to make the execution of the model secure on the compute block/engine. Additional details of trust and security built into the AI system are found in commonly owned Application Attorney Docket No. Set 1/1403394.00002, titled SYSTEMS AND METHODS OF SECURITY FOR TRUSTED AI HARDWARE PROCESSING, filed on Feb. 4, 2019, which is incorporated herein by reference in its entirety.

In one aspect, the AI system lane comprises a sequencer 105. The sequencer directs AI chain execution flow as per the inter-block and intra-block transaction definition 145. An AI system lane composer and virtual lane maintainer provides the required definition. The sequencer 105 maintains a queue and a status table. The queue contains model identification (ID), type of methods and configuration data for the layer(s). The model ID differentiates the model being executed. The methods inform the sequencer the type of re-configurable AI compute engine blocks to use. Configuration data contains the macro parameters that are required by the engines to execute the model properly. The status table contains the status of all the AI processing blocks. The table maintenance is active whether the AI processing block is busy or idle. All the operations will be queued by the lane orchestrator in the sequencer 105. The sequencer will trigger the operation from the queue depending on the available AI-PLU block which is idle. Once an operation is completed by the AI-PLU block, the sequencer 105 will change the corresponding entry to idle in the status table and reports it to the lane orchestrator about the completion. The lane orchestrator will now ask the AI system lane for the transfer of the output if all the tasks related to the input with respect to the model are completed.

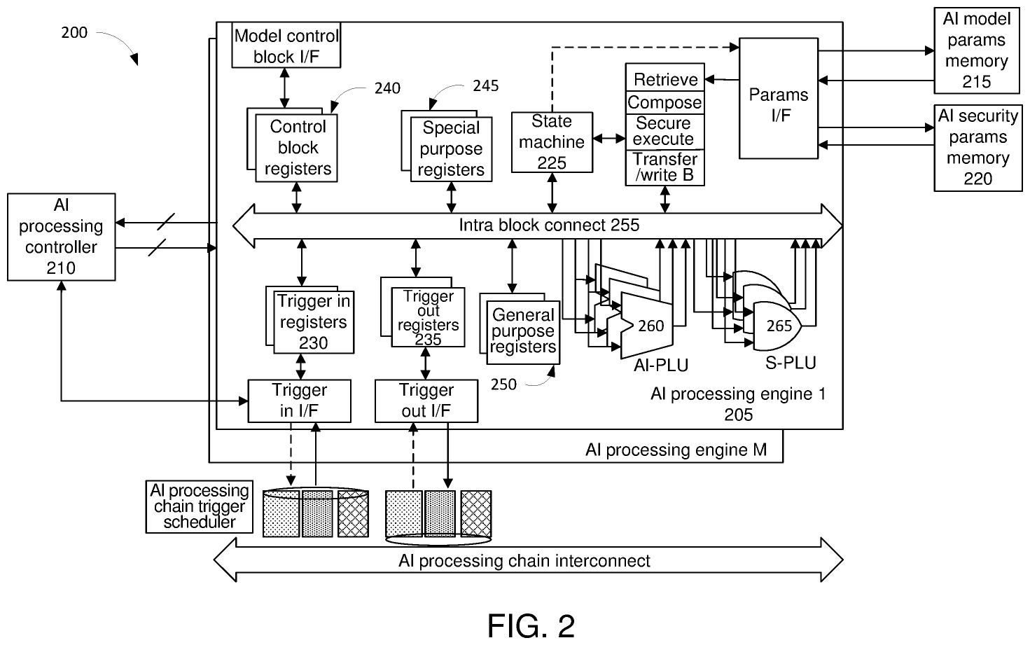

FIG. 2 is a diagram 200 of a secure re-configurable AI compute engine block 115 (see e.g., FIG. 1) with no traditional software overhead during model execution (inference or training) for speed and efficiency, in accordance with at least one aspect of the present disclosure. As used herein, the secure re-configurable AI compute engine block 115 comprises at least one AI processing engine 205 (shown here are multiple engines 1 through M), an AI processing controller 210 coupled to the processing engine(s) 205, an AI solution model parameters memory 215 coupled to the processing engine(s) 205, and an AI security parameters memory 220 coupled to the processing engine(s) (205. The processing engine comprises a state machine 225, trigger in/out registers 230 and 235, a control register 240, a special purpose register 245, a general purpose register 250, and an intra block connect bus 255 for communication and control between the registers 230, 235, 245, 250, control blocks 240, and state machine 225. The processing engine also comprises AI processing logic units (AI-PLUs) 260 and security processing logic unit (S-PLUs) 265 coupled to the intra block connect bus 255.

In one aspect, the AI compute engine block 115 comprises a plurality of processing engines 205 configured to trigger the state machine 225 for different memory and control transactions. The AI compute engine block 115 manages the chain of triggers required to complete a subsequent layer and also manages the memory transaction triggers. Control transaction includes triggering the state machine 225 corresponding to the method, software resetting the processing engine, etc. The compute engine block 115 also manages the memory triggers triggered by the state machine 225 such as write or read. The memory master, which resides outside of the AI compute engine block 115, will trigger the state machine 225 once the memory transaction triggered by the state machine 225 is completed. So all the combination of AI method trigger, memory transaction trigger, and software reset is managed by the trigger in/out registers 230 and 235.

In one aspect, the AI compute engine block processing engine(s) 205 comprises AI processing logic units (AI-PLUs) 260. Each of the AI-PLUs contains a set of multiplier, comparators and adders functional units. This fabric of functional units can be configured by the AI parameters to process AI methods such as CNN forward/backward, fully connected (FC) forward/backward, max-pooling, un-pooling, etc. This configuration is dependent on the dimensions of the model, type of the AI method and memory width (number of vector inputs that can be fetched at a single clock). The AI-PLU(s) 260 can process wide vectors at a single clock in a pipelined configuration. Hence it has high performance and is energy efficient.

In one aspect, the AI compute engine block processing engine(s) 205 comprises security processing logic units (S-PLUs) 265. Each of the S-PLUs contains a set of cryptographic primitives such as hash functions, encrypt/decrypt blocks, arranged in parallel and pipelined configuration to implement various security/trust functions. This fabric of functional units can be configured with the security parameters to process certain security features. These configurations are directed by the security policy engine. It can process wide security processing vectors at a single clock in a pipelined configuration. Hence, it has high performance and is energy efficient. In addition to protecting the AI application/solution models, S-PLUs in conjunction with AI-PLUs and other security and trust features built on to the AI system can run AI driven security applications for a range of use cases and markets.

In one aspect, the AI compute engine block processing engine(s) 205 comprises a state machine 225. The state machine 225 is the brain of the AI compute engine block. The state machine 225 takes control input and does the required task to complete the computation. The state machine 225 contains four major states: retrieve, compose, execute, and transfer/write back state. The behavior of the state machine 225 can be configured using the parameter set by the configure module namely, security parameters, AI application model parameters, etc. The state machine 225 can run inference or back propagation depending on type of flow chosen. It engages extra PLU's for weight update and delta calculation. In various states, the state machine 225 interfaces with the AI solution model parameters memory and the AI security parameters memory via a parameters interface (I/F).

Embedded as part of the AI compute block within the present AI Lane architecture is the flexible hardware AI model processing part of the state machine 225 in conjunction with the AI-PLUs/AI Logic blocks as defined in this disclose. If security is enabled, as described in (Set 1), the AI compute engine state machine 225 is invoked and once security is ascertained, AI processing takes place. Flexibility of the state machine 225 is driven by the AI model param structure for a given AI solution model as identified by an AI model execution context ID.

An AI solution model params structure is a chain of AI solution model parameter elements, where each element contains information, such as: 1) AI solution execution that dictates the invocation of specific AI feature; and 2) additional parameters needed for the corresponding AI feature.

The AI model state machine 225 runs through completion until all the elements in the chain are executed.

The AI model param structure with chain of AI model elements can be dynamically configured by or on behalf of a user for a given AI model execution context that can be customized to suit the user's needs. This model parameter structure can be stored and accessed using a regular structure block chain structure.

In some embodiments, the steps of the state machine are for a given AI Model Execution Context with a AI Model execution Context ID include:
Read the AI Model param structure for a given AI Model Execution context with Model Id
For each element in the AI Model param structure chain:
   i. Retrieve and Decode the next AI Model Param element. For example, back propagation operation may be performed, corresponding AI PLUs to be used, required data context etc.;
   ii. Compose for the corresponding AI PLU/HW Block with required parameters provide in the AI Model parameter element block;
   iii. Invoke and Execute AI PLU with the AI Model Context Execution ID;
   iv. Transfer/Write back result data to appropriate local scratch pad/memory location;
   v. Is next element in the chain, then go to step i.

More specifically, the retrieve state retrieves the input from the local memory of the AI system lane as described with reference to FIG. 1. Returning now to FIG. 2, the retrieve state also may retrieve the partial output from the previous iteration depending on the data dependency of the computation. If security is enabled, the retrieve state also retrieves security related parameters and credentials.

The compose state composes the input to the AI-PLUs of the AI compute engine 115. This depends on the input length, number of parallel hardware present PLU of the engine and also aligns the inputs in the order in which the parallel hardware in the PLU will process the data.

Once the data is composed, the execute state provides the execute signal to one or more sub-blocks/PLUs (S-PLUs and AI-PLUs) to process the input data.

The transfer/write back state writes back the partial results from the PLUs output to a general purpose register or transfers the final output from the PLUs to the local memory.

In one aspect, the AI compute engine block processing engine 205 comprises a general purpose register 250. The general purpose register 250 stores temporary results. The general purpose register 250 is used to store the partial sum coming from the AI-PLU output. These registers are filled by the write back state of the state machine 225.

In one aspect, the AI compute engine block processing engine comprises a control block register 240. The control block register 240 contains the different model parameters required to control the state machine 225. The control block registers 240 are a set of parameters computed on the fly which is used by the state machine 225 to accommodate the input AI solution model with variable size into the specific width parallel hardware present in the AI-PLU hardware. Control registers are used by the state machine 225 to control execution of each state correctly. The control block registers interface with the AI system lane described with reference to FIG. 1 via a model control interface (I/F).

Returning now to FIG. 2, in one aspect, the AI compute engine block processing engine comprises special purpose registers 245. Special purpose registers 245 are wide bus registers used to perform special operations on a data vector at once. The special purpose register 245 may perform the bit manipulation of the input data vector to speed up the alignment of the vector required by the PLU to process the data. The special purpose register 245 may perform shifting/AND/OR/masking/security operations on the large vector of data at once. These manipulations are controlled by the state machine in the compose state. This vector of data from the special purpose is fed into the parallel PLU hardware to compute.

In one aspect, the AI compute engine block comprises an intra block connect bus 255. The intra block connect bus contains the control and data bus required to the communication with different block present within the AI compute engine block. The data path is a high bandwidth bus which supports wide data width data transfer (e.g., 256 bit/512 bit/1024 bit). The control path requires high bandwidth and less data width buses. Local memory is used by the AI compute engine blocks to compute. An interconnect bus within the lanes fills the local memory, which the AI compute engines use to compute the output. Accordingly, this makes the AI compute engine robust and hence does not require the interconnect bus for improved efficiency.

In one aspect, the AI compute engine block comprises AI solution model parameters stored in the AI solution models parameters memory 215 coupled to the processing engine. The state machine 225 reads and writes AI solution model parameters to and from the AI solution models parameters memory via the parameters interface (I/F). Each of the AI solution model parameters contains the configuration data such as input dimension of the model, weight dimension, stride, type of activation, output dimension and other macro parameters used to control the state machine. Thus, each layer could add up to 32 macro parameters.

In one aspect, the AI compute engine block comprises methods for controlling different functions. Here, macro parameters are used by the control block to set different control parameters to run a layer. These control parameters are used by the state machine hardware to perform different functions such retrieving, composing, executing, and transferring/writing back. The state machine 225 uses special purpose registers to compose the data using the control parameters. This composed data are given to the AI-PLU to execute and the result is transferred and written back to the general purpose registers 250. Trigger in/out register trigger memory transactions and the type of state machine to complete the job. The triggers are provided via trigger in/out interfaces (I/F). There are multiple parallel instances of processing engines running within the AI compute engine block.

In one aspect, the AI compute engine block comprises AI security parameters stored in the AI security parameters memory 220 coupled to the processing engine 205. The state machine 225 reads and writes AI security parameters to and from the AI security parameters memory via the parameters interface (I/F). The AI security parameters contain the security configuration data corresponding to the AI application model that is currently running. Furthermore, it is dictated by the policy engine.

In various aspects, the present disclosure provides an AI-PLU for high speed wide width and parallel vector processing for extreme speed and efficiency. In one aspect, a generic AI-PLU is a special type of AI sub-block with one or more wide width (>512 bits) multipliers, adders, comparators whose parallel and pipelined arrangement can be re-configured such that one or more sets can run parallel and results from one set to another transferred in a pipelined fashion with maximum performance and power efficiency. A re-configurable AI compute engine block as shown in FIG. 2 may contain one or more AI-PLUs. Based on various arrangements an AI-PLU can take the shape or be implemented as various AI-PLU instances, namely:

A. An AI system processing logic unit (AI-PLU) configured to perform a back propagation algorithm, as described in FIG. 3.

B. An AI system processing logic unit (AI-PLU) instance within a convolutional neural network (CNN) AI processing block/engine configured for forward/backward propagation, in accordance with at least one aspect of the present disclosure as described with reference to FIG. 4.

C. An AI-PLU instance within a max-pooling AI processing block/engine configured for forward/backward propagation, in accordance with at least one aspect of the present disclosure as described with reference to FIG. 5.

D. An AI-PLU instance within an un-pooling AI processing block/engine configured for back propagation, in accordance with at least one aspect of the present disclosure as described with reference to FIG. 6.

E. An AI-PLU instance within a fully connected-recurrent neural network (FC-RNN) AI processing block/engine configured for forward/backward propagation, in accordance with at least one aspect of the present disclosure as described with reference to FIG. 7.

It will be appreciated that a RNN is a class of artificial neural network, which has unlike feedforward networks recurrent connections. The major benefit is that with these connections the network is able to refer to last states and can therefore process arbitrary sequences of input. The basic difference between a feed forward neuron and a recurrent neuron is that the feed forward neuron has only connections from its input to its output and has two weights, for example. The recurrent neuron instead has also a connection from its output again to its input and therefore it has three weights, for example. The third extra connection is called feed-back connection and with that the activation can flow round in a loop. When many feed forward and recurrent neurons are connected, they form a recurrent neural network. In addition, to CNN, FC, or RNN networks, which are described herein by way of example and not limitation, a user can introduce other blocks. Accordingly, the present disclosure is not limited in this context.

Back Propagation Algorithm Complex

Referring to FIG. 3, shown is an example of how AI-PLUs may be configured to perform back propagation. For example, a back propagation algorithm complex of an AI-PLU is arranged in p parallel groups. Each parallel group has a z number of parallel back propagation error generation hardware. The Error function is dependent on the type of update done for the training and is re-configurable. There are p parallel Z element weight updaters, one for each parallel group. As shown, all these are arranged in a highly parallel and pipelined manner.

Here is an example of a state machine, e.g., state machine 225, operating a back propagation controller:

i. Decodes next element e.g., Back propagation algorithm element and parameters such as AI Model Context ID etc. The state machine then fetches AI Model Control Block using Model control block i/f using AI Model context ID, that has all the required parameters for the back prop algorithm, and corresponding data context for weight, input, layer information, etc.

ii. Composes and directs data buses to feed the weights, inputs, layer information to the AI-PLU during the operation.

iii. Invokes and Executes: Gives the appropriate control signal to do the operation to the AI-PLU to update the weight using the Z element weight updater 305. The AI-PLU then computes the error depending on the layer output, input and weight. This error is multiplied with a learning rate and subtracted from the original weights based on the update methodology configured in the Z element weight updater 305.

iv. Transfer. Finally, the controller directs the AI-PLU to store the updated weight in an appropriate location.

v. Once the new weight is generated, the controller repeats the above procedure for a delta calculation. It directs the data bus to feed the new weights and the delta to the AI-PLU to generate the new delta that will be fed to next layer in backward propagation.

FIG. 4 is a diagram of an AI system processing logic unit (AI-PLU) instance within a convolutional neural network (CNN) AI processing block/engine for forward/backward propagation, in accordance with at least one aspect of the present disclosure. In one aspect, the AI-PLU CNN instance contains an array of multiplier functional units, e.g., MUL unit 405, and adder functional units, e.g., Z element adder 410. The arrangement of the multiplier and adder functional units in the CNN is dependent on the weight dimension and on forward and backward flow, as described below.

In one aspect, the arrangement of the multiplier and adder functional units in the CNN is dependent upon the AI-PLU CNN forward instance. In forward flow, the functional units are arranged to multiply and add. The X rows represent the weight dimension and the Y columns represent the number of outputs that can be computed in parallel. Therefore, depending on the weight dimension, the number of outputs computed will decrease or increase. Smaller weight dimensions produce a large number of outputs. Similarly, larger weight dimensions produce a small number of outputs. All of these data paths are supported by multiplexing functional units depending on weight dimension. Input and weight is taken as the input. Both are multiplied and added. Then, depending on the activation, the output is moved to the output multiplexer. Here the computations are memory bound and hardware bound. The memory can fetch at least 64 byte/128 byte at a time. Therefore, the speed of the execution would depend on the available hardware. Hence, if the inputs required for calculating the Y outputs are within 64 Byte/128 bytes of the vector limit, then those outputs could be processed in the same cycle. For example, if M is the output dimension of the CNN output, then it would take (M/Y)*Weight of the row dimension cycle to compute M outputs. Again, the weight of the row dimension parameter can be removed if the multiple rows of weights can be fetched and make the input dependent on those multiple rows of weights.

In one aspect, the arrangement of the multiplier and adder functional units in the CNN is dependent upon the AI-PLU CNN backward instance. In backward flow, back propagation requires three computations. First is to calculate weight updates, second is to compute delta sum, and third is bias computation. In back propagation, the output width is variable. The output provided by the weight update AI-PLU is dependent upon the dimension of the weight. The new weight that is calculated is then forwarded to the delta sum processing engine to calculate the delta matrix. The input for the weight update is the delta from the previous layer, the learning rate, and the output of the previous layer. The delta sum computation requires the updated weight, learning rate, and the delta as the input to calculate the delta sum. Weight update is a summation of the previous weight plus-or-minus the new error. The AI-PLU will calculate the error using the previous layer output and the delta. The old weight is then updated with error values. The newly calculated weight is forwarded to delta sum updater that uses the new weight and delta value to calculate the delta sum. The bias update is a sum of old bias minus the error. The error is summation of all delta value times the learning rate. This error is subtracted from the old bias to get the updated bias. The weight update includes multiplication and adder units. The delta sum also includes shift, multiplication, and adder units

FIG. 5 is a diagram of an AI-PLU instance within a max-pooling AI processing block/engine for forward/backward propagation, in accordance with at least one aspect of the present disclosure. The AI-PLU max-pooling instance contains an array of comparators functional units, e.g., Z element comparator 505, for comparing an array of values/indices, e.g., value/index block 510. The arrangement of the functional units in max-pooling is dependent on the max-pooling dimension. The X rows define the max-pooling dimension. The Y columns indicate the number of outputs it could calculate for a given X dimension. Therefore, as the X row increases, the calculated Y column output decreases accordingly. The AI-PLU max-pooling instance also takes indexes as inputs. This output is used for the un-pooling in the backward propagation. Hence, input and input index are taken as the input. The comparator selects the maximum value and the index corresponding to the maximum value. This output is then passed to the output multiplexer.

The functional units are arranged to maximize the hardware utilization and throughput. The comparator 505 can compare both positive and negative values. All of the functional units are pipelined to process the input with an input valid signal to indicate the validity of the input. The output valid is asserted depending on the validity of the input. Consequently during pipelining a high throughput is achieved. The data output is moved to an output buffer, which will be used by other engines to compute their operation on it. These AI-PLU instance(s) use the width bus. Hence they can consume a vector in a single clock to produce the result. They are fast and the AI-PLU instance(s) are tailored to accept more inputs depending on the hardware available. Consequently these AI-PLU instance(s) are efficient and fast.

FIG. 6 is a diagram of an AI-PLU instance within an un-pooling AI processing block/engine for back propagation, in accordance with at least one aspect of the present disclosure. In one aspect, back propagation un-pooling is employed. For example, back propagation employs the index output from the corresponding max-pooling output in the forward loop and the delta output. The delta output or the index output, e.g., delta/index block 605, is then use as the address and the delta output value is stored at the location indicated by the address. The Z element unpooler 610 is configured to un-pool the delta or index output. Therefore, only a single value can be mapped at one point in time. Hence, un-pooling is run in parallel on different depths of the data to speed up the algorithm. Here, the Y columns denote the number of the un-pooling algorithms running parallel at a given point in time. The delta and index are fed to an un-pooler 610 to place the data at the position denoted by the index. The output computed is moved to the local buffer which will transfer the data to the local memory and will be used by other engines. The Y column un-pool functions are triggered asynchronously and after a Y column completes its operation, the data is saved in the output buffer. This will be used as the input by the CNN backward as the input delta. These AI-PLU instance(s) use the width bus to read and write the data. Hence, large length vectors are read, which are used to for computation to produce a large output in a single cycle.

FIG. 7 is a diagram of an AI-PLU instance within a FC-RNN (fully connected-recurrent neural network) AI processing block/engine for forward/backward propagation, in accordance with at least one aspect of the present disclosure. A recurrent neural network (RNN) is a class of artificial neural network where connections between nodes form a directed graph along a sequence. This allows it to exhibit temporal dynamic behavior for a time sequence. Unlike feedforward neural networks, RNNs can use their internal state (memory) to process sequences of inputs. This makes them applicable to tasks such as unsegmented, connected handwriting recognition or speech recognition. The term “recurrent neural network” is used indiscriminately to refer to two broad classes of networks with a similar general structure, where one is finite impulse and the other is infinite impulse. Both classes of networks exhibit temporal dynamic behavior. A finite impulse recurrent network is a directed acyclic graph that can be unrolled and replaced with a strictly feedforward neural network, while an infinite impulse recurrent network is a directed cyclic graph that cannot be unrolled. Both finite impulse and infinite impulse recurrent networks can have additional stored state, and the storage can be under direct control by the neural network. The storage can also be replaced by another network or graph, if that incorporates time delays or has feedback loops. Such controlled states are referred to as gated state or gated memory, and are part of long short-term memory networks (LSTMs) and gated recurrent units.

In one aspect, in an FC configuration, a single synapse output is computed using the multiply accumulate of weights and inputs vector pertaining to the synapse. Therefore, the AI-PLU FC instance contains Y columns of the multiply accumulate units, e.g., block 705, etc. It has X rows and Y columns of multiply accumulate units 705. The accumulation is done using a tree structure in some embodiments. The tree structure provides a pipeline behavior to the hardware. Hence, every clock cycle can push inputs to the AI-PLU FC instance. In one example iteration, the computation of a synapse, weight, and input corresponding to one synapse is provided as input to the AI-PLU FC instance. Therefore, each clock cycle of the AI-PLU FC instance can accept X*Y inputs and weights. Accordingly, if the length of the weight vector is N, then X*Y/N number of inputs can be fit in each clock cycle. All of the partial sums from each of the iterations, if dependent, are accumulated separately. The number of computations to the FC is memory bound and dependent on the hardware available in the AI-PLU instance. The speed of execution of the algorithm depends on the number of inputs read and the number of parallel hardware available.

In the RNN, multiple synapses constitute a single cell. Hence, each output is dependent on the multiple synapse computation. RNN computation is a fusion of multiple FC computations. Hence, the FC and RNN configurations use generally the same PLU structure. It can support RNN computations such as GRU and LSTM.

FIG. 8 is a diagram of an AI-PLU instance within a machine learning classification processing block, in accordance with at least one aspect of the present disclosure. Machine learning algorithms are supported by the machine learning AI-PLU. It contains classifier logic, e.g., block 805, arranged in an array format to perform the different machine learning classifications on the data. The input data is fed into the array of classifiers 805, and the output is again classified by the z-element classifier 810.

FIG. 9 is a diagram of an AI-PLU instance within a sort processing block, in accordance with at least one aspect of the present disclosure. In a sorting PLU, multiple sorting blocks, e.g., block 905, are arranged in the array format. Each sorting block can take two inputs. The output is combined by the z-element sorter 910. Therefore, multiple inputs will be fed to the AI sorter PLU. The output that is provided is sorted. The iteration will be run for all the elements in the array to be sorted.

In some aspects, the sort blocks 905 may be inputs to pattern matcher 915. The pattern matching may take two or more inputs of the sort logic block values and determine patterns in the values. Similarly, the sort blocks 905 may be inputs to a hash pattern matcher 920, which may provide a hash pattern matching of the sort logic block values.

In various aspects, the present disclosure provides an AI system security processing logic unit (S-PLU) for high speed wide width and parallel processing of security functions for extreme speed and efficiency. A generic S-PLU is a special type of sub-block with one or more wide width (>512) hash/digest, encryption, decryption, pattern matching, nonce, and other foundation functions whose parallel and pipelined arrangement can be re-configured such that one or more sets can run in parallel and the results from one set can be transferred to another set in a pipelined fashion with maximum performance and power efficiency. A re-configurable AI compute engine block may contain one or more S-PLUs. Based on various arrangements, an S-PLU can be implemented or take shape as various S-PLU instances, namely:

An AI S-PLU instance configured for cryptography—PKI encryption/decryption, in accordance with at least one aspect of the present disclosure as described with reference to FIG. 10A. This diagram represents a functional block description of how hardware blocks may be logically coupled to perform encryption and decryption that is described more at a functional level in (Attorney Docket No. Set 1/1403394.00002, U.S. Provisional Application No. 62/801,044, titled SYSTEMS AND METHODS OF SECURITY FOR TRUSTED AI HARDWARE PROCESSING; again incorporated herein by reference).

Still referring to FIG. 10A, there is shown a diagram of an AI S-PLU instance for cryptography—PKI encryption/decryption, in accordance with at least one aspect of the present disclosure. The model data (such as weights and bias) and network information is encrypted. The AI S-PLUs are used to encrypt/decrypt the data. The input/model data that comes in is decrypted and the output data that goes out of the lane is encrypted. The configuration data also is encrypted to avoid leaking of the lucrative network structure of the model. The encryption and decryption function units are arranged in array with X rows and Y columns. The inputs are read and fed into the AI S-PLU encrypt/decrypt functional module. The encryption or decryption algorithm is selected depending on the format of the data. This functional unit is run in parallel and pipeline. Hence this AI S-PLU has a high throughput.

For example, in some aspects, as shown in FIG. 10A, the Encrypt/Decrypt blocks, e.g., block 1005, of an S-PLU may be arranged in p parallel groups. Each parallel group has a z number of basic block encrypt/decrypt logic. One of the encrypt/decrypt block 1005 may include the following blocks as shown in FIG. 10B. There is a block controller, and a sub-controller to form the general controller apparatus, that manages multiple encrypt/decrypt engines/algorithms, e.g., AES, DES, SHA, and Block Fish.

In general, the controller apparatus has several functions:

Interact with security state machine;

Manage security keys;

Retrieve or store AI solution model to be encrypted/decrypted; and

Interact with sub-controller corresponding to each group.

For speed and hyper-parallelism, AI solution model-related data that is to be encrypted/decrypted is chunked into p equal-size chunks (depending on the size of the data, some cases and some groups may not get any data). Each chunk is an integral multiple of 64-bit/128-bit/x-bits corresponding to the block encryption/decryption size. Each chunk is delivered to the corresponding sub-controller of the group.

Each chunk is identified with a sequence number, so that, once operation completed by the sub-controllers, the controller can combine data in the order it sent to the sub-controllers.

In addition to data processing, the controller sends configuration information, including security keys and the type of encrypt/decrypt to perform to sub-controllers.

In general, each sub-controller further schedules the blocks from the data chunk with a block ID and then sends the block to the block controller of the available basic block encrypt/decrypt logic.

Once the operation is complete, it assembles all the block results to create a result chunk in sequence order identified with a block ID. Once assembled, it returns the result chunk with a sequence number to the controller.

In addition to data processing, the sub-controller sends configuration information, including security keys, to the block-controller 1055.

In general, the block-controller 1055 interacts with the sub-controller to receive:

1. Configuration info, including security keys, the type of encryption/decryption to perform, and populates appropriate register and/or activates appropriate signals.

2. Receives block data to be encrypted/decrypted and invokes and sends block data to the corresponding crypto engine (e.g., DES, AES, Blowfish, SHA) to encrypt/decrypt the block data.

3. Sends the received encrypted/decrypted result back to the sub-controller 1055 with the block ID.

This S-PLU is extremely fast and efficient in processing the encryption/decryption of AI solution model data.

An AI S-PLU instance configured for cryptography—hash function, in accordance with at least one aspect of the present disclosure as described with reference to FIG. 11. Hashing is used to check the integrity of the data, e.g., model or network configuration. The hashing can be run on entire model or just the configuration data. Accordingly, hashing is done using an S-PLU hashing instance. The hashing function units are arranged in an array with X rows and Y columns. The inputs are read and fed into the S-PLU hashing functional module. The hashing algorithm is selected depending on the format of the data. This functional unit is run in parallel and pipelined. Hence this AI S-PLU has a high throughput.

Each of the hash blocks, e.g., block 1105, may serve as inputs to a hash encrypt/decrypt block 1110. The output of each hash decrypt block 1110 may be digested and serve as additional inputs to a new hash block 1105, along with multiple other outputs from other hash encrypt/decrypt blocks 1110. The cyclic feedback may result in an efficient way to perform cryptography.

An AI S-PLU instance configured for pattern matching, in accordance with at least one aspect of the present disclosure as described with reference to FIG. 12A.

Pattern Matching is used to find virus or worms of the data i.e., model or network configurations. The virus and worm can modify the weights which will make the algorithm classify the wrong output. So Hashing is done using S-PLU hashing instance. The Pattern matching function units are arranged in array with X rows and Y columns. The inputs are read and fed into the S-PLU pattern matching functional module. The pattern matching algorithm is selected depending on the format of the data. This functional unit is run in parallel and pipelined. Hence this AI S-PLU has a high throughput.

In some aspects, the basic block of the pattern matching PLU is the NFA/DFA block 1205. Referring to FIG. 12B, a zoomed in view of the NFA/DFA block 1205 is shown, where CB is a comparator block 1255.

For speed and hyper-parallelism, AI solution model-related data arriving to the S-PLU via the bus is broadcasted to each parallel group at the rate of n-bytes at each clock cycle. Within each parallel group, incoming stream data is further broadcasted to each basic pattern-matching block and is pipelined at n-bytes at each clock cycle.

The basic pattern-matching logic NFA/DFA can compare two unique programmable patterns at a time. This basic pattern-matching architecture is much faster than any software implementation. In the software, the complexity is O(ml), where m is number of states and 1 is the length of the input. In the present embodiments, the basic pattern matcher complexity is O(m/(2*n)), where m is number of states and is the length of the input, and n is the number of comparisons per cycle.

With the above inventive parallel arrangement, the present embodiments can match p*z*2 patterns at a time per clock cycle.

Example operation of the pattern matching PLU:

The security state machine invokes the S-PLU along with the AI solution model context ID and other S-PLU pattern -matching parameters.

Using the model context ID, corresponding model-related data is taken by the S-PLU and fed into its parallel logic as specified earlier.

If there are one or more pattern matches, they are returned to the state machine.

Security patterns can be dynamically configured for a given context.

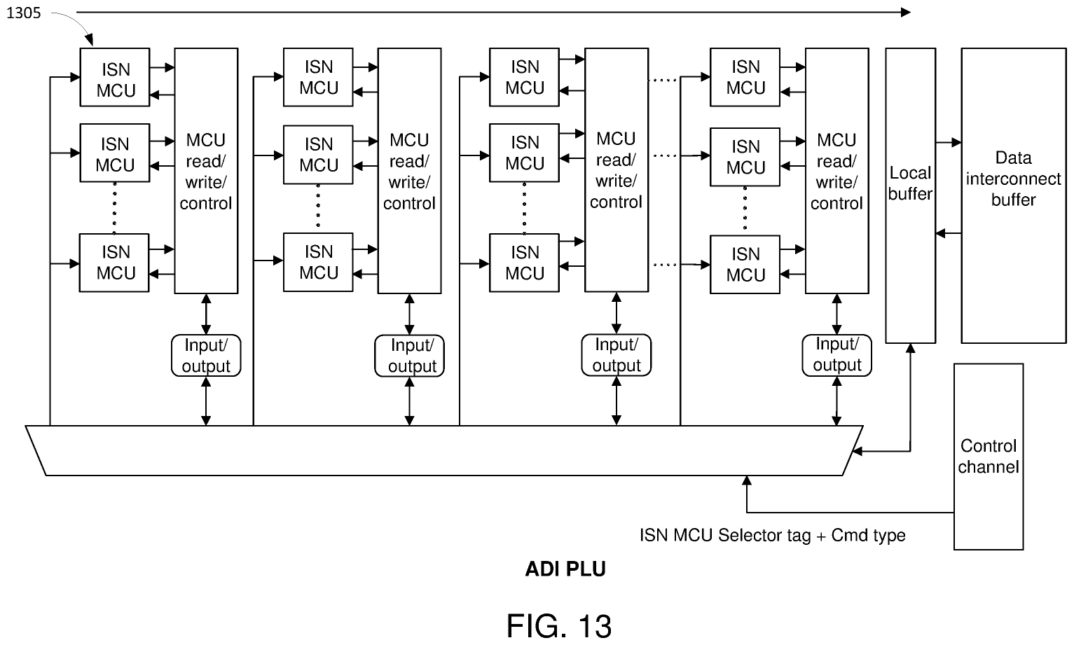

FIG. 13 is a diagram of an adaptive intelligent processing logic unit (ADI-PLU) comprising a collection of intelligent sense neuro memory cell units (ISN MCUs), e.g., ISN MCU block 1305, in accordance with at least one aspect of the present disclosure. An ADI-PLU may contain a homogeneous or a heterogeneous collection of ISN MCUs and acts like a memory block and connected to a data and control interconnect. In one aspect, a collection of ISN MCUs sense learning cells with AI learning, training and inference are addressable like memory cells. Each of the ISN MCUs within a ADI-PLU can be accessed (read/write) just like one or more memory cell(s) using appropriate selector tag and command type.

There can be one or more ADI-PLUs than be interconnected via a hierarchical non-blocking interconnect bus with lookup and forwarding table for automatic forwarding of data between ADI-PLUs and their respective ISN MCUs. The type of forwarding from/to ADI-PLU and their respective ISN MCUs includes one-to-one forwarding, one-to-many forwarding, many-to-one forwarding and many-to-many forwarding, respectively.

Moreover, an ADI-PLU can be accessed from a re-configurable AI compute engine as a typical memory block. It can be defined, organized, tied to the overall AI processing chain. Multiple sets of ADI-PLUs can be accessible from a re-configurable AI compute engine as described herein. ADI-PLUs can be organized for instance to represent a set of inputs, weights and outputs that can represent a user specified AI learning model. Instead of training in the traditional processing domain, they are sense learned and adjusted and stored in multi-bit memory cells to represent values that may correspond to an AI learning model input, weight and output. Creating the model and associating the sense input, weight and output to the AI learning model can be done by domain specific scientists based on a given problem and its expected outcome or can be done automatically through re-enforced feedback learning.

The following is a comparison of the above AI system and advantages thereof. The present AI system provides a built in AI application solution centric secure AI hardware computer with built-in security without the intervention of a CPU or a GPU or software framework or OS dependency. For example, a GPU runs on threads which are controlled and coordinated by software. In contrast, the present AI system runs threads which are controlled by hardware using state machines.

Further, a GPU uses floating point hardware calculations for most of the calculations. In contrast, the present AI system uses fixed point hardware for computations. Hence it uses less latency and less energy to calculate output. Fixed point functional units need less hardware hence more hardware can be crammed into an integrated circuit chip as compare to a GPU with the same number of resources. Hence more computations can be performed.

Further, the present AI system contains PLUs which run on layer level granularity. Hence each layer is computed in a highly pipelined/parallel manner with no cache/memory misses for that layer. In contrast, a GPU runs on an addition and multiplication level of granularity. Hence each layer will run a swarm of threads which complete for the resource to finish. Hence it takes more time and energy to complete. It will be appreciated, however, that the present AI system may include fixed point hardware for computations. Accordingly, the present disclosure is not limited in this context.

Further, each PLU can be configured to compute CNN forward or CNN backward etc. Hence the hardware resources are connected in the data path to compute the CNN forward algorithm or the CNN backward algorithm. Therefore, the data path with control logic executes the algorithm. Hence they involve very low latency. In contrast, in a GPU, the hardware is a general purpose SIMD architecture. Therefore, all the algorithms are controlled by the software code. Hence the output is computation will be waiting for microcode to execute. Hence it takes more cycles to complete.

Further, the present AI system contains security functions such as hashing, encrypt/decrypt and pattern matching hardware. Encryption blocks help encrypt the output so that only intended user can read. The decryption block can decrypt the model depending on the availability of the key. The hashing block can check for the integrity of the model and network structure. Pattern matching hardware can check for the virus signatures in the model data. Hence all stages of security are present in the AI system lane which makes it more secure. Again the security engines are energy efficient since the hardware is pipelined and parallel. Hence only a small amount of power is used for security of the model execution. In contrast, a GPU does not contain any security engine to check for the integrity of the program executing. Hence it doesn't provide any security measure to fight different attacks.

Further, a GPU hides its memory latency by executing a large number of threads at the same time. Hence after the execution, each thread is available to occupy a compute block. Therefore, efficiency of the hardware is good when executing the same layer for more numbers of inputs. Hence they employ batch processing and real time processing is not possible. In contrast, in the present AI system, the AI solution model is executed with layer wise pipeline and parallelism. Hence layers are executed one after the other. Therefore, the intermediate layer output is reused by the next layer. Accordingly, there is no back and forth of the intermediate results from the global memory to local memory. Hence there is no delay between the execution of two consecutive layers. Hence real time input processing achieved.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skilled in the art in light of this disclosure. In addition, those skilled in the art will appreciate that the mechanisms of the subject matter described herein are capable of being distributed as one or more program products in a variety of forms and that an illustrative form of the subject matter described herein applies regardless of the particular type of signal-bearing medium used to actually carry out the distribution.

Instructions used to program logic to perform various disclosed aspects can be stored within a memory in the system, such as DRAM, cache, flash memory, or other storage. Furthermore, the instructions can be distributed via a network or by way of other computer-readable media. Thus a machine-readable medium may include any mechanism for storing or transmitting information in a form readable by a machine (e.g., a computer), but is not limited to, floppy diskettes, optical disks, CD-ROMs, magneto-optical disks, ROM, RAM, EPROM, EEPROM, magnetic or optical cards, flash memory, or tangible, machine-readable storage used in the transmission of information over the Internet via electrical, optical, acoustical, or other forms of propagated signals (e.g., carrier waves, infrared signals, digital signals). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, DSP, PLD, programmable logic array (PLA), or FPGA), state machine circuitry, firmware that stores instructions executed by programmable circuitry, and any combination thereof. The control circuit may, collectively or individually, be embodied as circuitry that forms part of a larger system, for example, an integrated circuit, an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application-specific integrated circuit, electrical circuitry forming a general-purpose computing device configured by a computer program (e.g., a general-purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets, and/or data recorded on non-transitory computer-readable storage medium. Firmware may be embodied as code, instructions, instruction sets, and/or data that are hard-coded (e.g., non-volatile) in memory devices.

As used in any aspect herein, the terms “component,” “system,” “module,” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet-switched network. The communication devices may be capable of communicating with each other using a selected packet-switched network communications protocol. One example communications protocol may include an Ethernet communications protocol which may be capable permitting communication using a Transmission Control Protocol/IP. The Ethernet protocol may comply or be compatible with the Ethernet standard published by the Institute of Electrical and Electronics Engineers (IEEE) titled “IEEE 802.3 Standard,” published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum, titled “ATM-MPLS Network Interworking 2.0,” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, and/or standby-state components, unless context requires otherwise.

Those skilled in the art will recognize that, in general, terms used herein, and especially in the appended claims (e.g., bodies of the appended claims), are generally intended as “open” terms (e.g., the term “including” should be interpreted as “including, but not limited to”; the term “having” should be interpreted as “having at least”; the term “includes” should be interpreted as “includes, but is not limited to”). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations or two or more recitations). Furthermore, in those instances where a convention analogous to “at least one of A, B, and C, etc.” is used, in general, such a construction is intended in the sense that one having skill in the art would understand the convention (e.g., “a system having at least one of A, B, and C” would include, but not be limited to, systems that have A alone, B alone, C alone, A and B together, A and C together, B and C together, and/or A, B, and C together). In those instances where a convention analogous to “at least one of A, B, or C, etc.” is used, in general, such a construction is intended in the sense that one having skill in the art would understand the convention (e.g., “a system having at least one of A, B, or C” would include, but not be limited to, systems that have A alone, B alone, C alone, A and B together, A and C together, B and C together, and/or A, B, and C together). It will be further understood by those within the art that typically a disjunctive word and/or phrase presenting two or more alternative terms, whether in the description, claims, or drawings, should be understood to contemplate the possibilities of including one of the terms, either of the terms, or both terms, unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures, or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials are not inconsistent herewith. As such, and to the extent necessary, the disclosure as explicitly set forth herein supersedes any conflicting material incorporated herein by reference. Any material, or portion thereof, that is said to be incorporated by reference herein but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

### EXAMPLES

Various aspects of the subject matter described herein are set out in the following numbered examples:

Example 1. An artificial intelligence (AI) system lane, comprising: a re-configurable AI compute engine; a local memory; a common method processor; an AI application data management buffer; and a sequencer; wherein the re-configurable AI compute engine, the internal memory, the common method processor, the AI application data management buffer, and the sequencer are coupled via AI processing chain interconnects, comprising data interconnect bus and inter-block AI processing chain interconnects; wherein the data interconnect bus transfers data within the re-configurable AI compute engine block and transfers data to the local memory; wherein the AI processing interconnect bus carries control information; and wherein the re-configurable AI compute engine block is configured to compute AI methods assigned by the sequencer.

Example 2. The AI system lane of Example 1, wherein the sequencer comprises a state machine with at least one configurable AI programmable logic units (AI-PLUs) to process an AI application/model.

Example 3. The AI system lane of Example 2, wherein the sequencer is configured to maintain the at least one configurable AI-PLU to compute different type of methods.

Example 4. The AI system lane of any one of Examples 1 to 3, wherein the local memory is a high speed memory interfaced to the AI application data management buffer hardware, wherein the internal memory comprises data, layer results, weights, and inputs required by the AI system lane to execute.

Example 5. The AI system lane of any one of Examples 1 to 4, wherein the common method processor comprises hardware to process common functions.

Example 6. The AI system lane of any one of Examples 1 to 5, wherein the AI application data management buffer is configured to manage the internal memory requirement between the re-configurable AI compute engine, the local memory, the common method processor; and the sequencer.

Example 7. The AI system lane of Example 6, wherein the AI application data management buffer is configured to maintain data transfer between the local memory and external memory.

Example 8. The AI system lane of any one of Examples 1 to 7, further comprising a security policy engine coupled to the re-configurable AI compute engine, the internal memory, the common method processor, the AI application data management buffer, and the sequencer are via the inter-block AI processing chain interconnects.

Example 9. The AI system lane of Example 8, wherein the security policy engine comprises at least one security programmable logic unit (S-PLU) configured to: process security related features; provide security to the AI system lane; and enable a range of AI driven security applications.

Example 10. A secure re-configurable AI compute engine, comprising: a processing engine; an AI processing controller coupled to the processing engine; an AI solution model parameters memory coupled to the processing engine; and an AI security parameters memory coupled to the processing engine; wherein the processing engine comprises: at least one AI processing logic unit (AI-PLU); at least one security processing logic unit (S-PLU); a local memory; a state machine state comprising a retrieve state, a compose state, an execute state, and a transfer/write back state; trigger in/out registers; at least one control register; at least one special purpose register; at least one general purpose register; and wherein the at least one AI-PLU, the at least one S-PLU, the state machine, the trigger in/out registers, the at least one control register, the at least one special purpose register, and the at least one general purpose register are coupled via an intra block connect bus for communication and control.

Example 11. The secure re-configurable AI compute engine of Example 10, wherein the retrieve state of the state machine is configured to retrieve input from a local memory of an AI system lane.

Example 12. The secure re-configurable AI compute engine of Example 10 or 11, wherein the compose state of the state machine is configured to compose an input to the at least one AI-PLU.

Example 13. The secure re-configurable AI compute engine of any one of Examples 10 to 12, wherein the execute state of the state machine is configured to provide an execute signal to the at least one S-PLU or the at least one AI-PLU, or a combination thereof to process input data.

Example 14. The secure re-configurable AI compute engine of any one of Examples 10 to 13, wherein the transfer/write back state of the state machine is configured to write back partial results from an output of the at least one AI-PLU or the at least one S-PLU to the general purpose register or to transfer a final output from the at least one AI-PLU or the at least one S-PLU to the local memory.

Example 15. The secure re-configurable AI compute engine of any one of Examples 10 to 14, wherein the at least one AI-PLU comprises: a set of multipliers; a set of comparators; and a set of adders; wherein the set of multipliers, comparators, and adders are configured by the AI parameters to process AI methods based on dimensions of the AI solution model, type of AI method, and memory width; and wherein the at least one AI-PLU is configured to process vectors at a single clock in a pipelined configuration.

Example 16. The secure re-configurable AI compute engine of Example 15, wherein the AI methods comprise convolutional neural network (CNN) forward/backward, fully connected (FC) forward/backward, max-pooling, or un-pooling, or a combination thereof.

Example 17. The secure re-configurable AI compute engine of any one of Examples 10 to 16, wherein the at least one AI-PLU is implemented as at least one AI-PLU instance.

Example 18. The secure re-configurable AI compute engine of Example 17, wherein the at least one AI-PLU instance comprises a convolutional neural network (CNN) AI processing block/engine configured for forward/backward propagation.

Example 19. The secure re-configurable AI compute engine of Examples 17 or 18, wherein the at least one AI-PLU instance comprises a max-pooling AI processing block/engine configured for forward/backward propagation.

Example 20. The secure re-configurable AI compute engine of any one of Examples 17 to 19, wherein the at least one AI-PLU instance comprises an un-pooling AI processing block/engine configured for back propagation.

Example 21. The secure re-configurable AI compute engine of any one of Examples 17 to 20, wherein the at least one AI-PLU instance comprises a fully connected-recurrent neural network (FC-RNN) AI processing block/engine configured for forward/backward propagation.

Example 22. The secure re-configurable AI compute engine of any one of Examples 10 to 21, wherein the at least one S-PLU comprises: a set of cryptographic primitives including hash functions or encrypt/decrypt blocks arranged in parallel and pipelined configuration to implement security/trust functions.

Example 23. The secure re-configurable AI compute engine of any one of Examples 10 to 22, wherein the at least one S-PLU is implemented as at least one S-PLU instance.

Example 24. The secure re-configurable AI compute engine of Example 23, wherein the at least one S-PLU instance comprises at least one S-PLU instance configured for cryptography.

Example 25. The secure re-configurable AI compute engine of Example 24, wherein the at least one S-PLU instance configured for cryptography comprises at least one PKI encryption/decryption.

Example 26. The secure re-configurable AI compute engine of Examples 24 or 25, wherein the at least one S-PLU instance configured for cryptography comprises at least one hash function.

Example 27. The secure re-configurable AI compute engine of any one of Examples 23 to 26, wherein the at least one S-PLU instance comprises at least one S-PLU instance configured for pattern matching.

Example 28. The secure re-configurable AI compute engine of any one of Examples Example 10 to 27, further comprising at least one adaptive intelligent processing logic unit (ADI-PLU).

Example 29. The secure re-configurable AI compute engine of any one of Examples 10 to 28, further comprising fixed point computation hardware.

Example 30. The secure re-configurable AI compute engine of any one of Example 10 to 29, further comprising floating point computation hardware.

Example 31. The secure re-configurable AI compute engine of any one of Examples 10 to 30, further comprising a combination of fixed point and floating point computation hardware.

Example 32. The secure re-configurable AI compute engine of any one of Examples 10 to 31, wherein AI processing is defined through configuration.

Example 33. The secure re-configurable AI compute engine of any one of Examples 10 to 32, wherein security processing is defined through configuration.

What is claimed is:

1. An artificial intelligence (AI) system lane, comprising:
a re-configurable AI compute engine;
a local memory;
a common method processor;
an AI application data management buffer; and
a sequencer;
wherein the re-configurable AI compute engine, the internal memory, the common method processor, the AI application data management buffer, and the sequencer are coupled via AI processing chain interconnects, comprising data interconnect bus and inter-block AI processing chain interconnects;
wherein the data interconnect bus transfers data within the re-configurable AI compute engine block and transfers data to the local memory;
wherein the AI processing interconnect bus carries control information; and
wherein the re-configurable AI compute engine block is configured to compute AI methods assigned by the sequencer.

2. The AI system lane of claim 1, wherein the sequencer comprises a state machine with at least one configurable AI programmable logic units (AI-PLUs) to process an AI application/model.

3. The AI system lane of claim 2, wherein the sequencer is configured to maintain the at least one configurable AI-PLU to compute different type of methods.

4. The AI system lane of claim 1, wherein the local memory is a high speed memory interfaced to the AI application data management buffer hardware, wherein the internal memory comprises data, layer results, weights, and inputs required by the AI system lane to execute.

5. The AI system lane of claim 1, wherein the common method processor comprises hardware to process common functions.

6. The AI system lane of claim 1, wherein the AI application data management buffer is configured to manage the internal memory requirement between the re-configurable AI compute engine, the local memory, the common method processor; and the sequencer.

7. The AI system lane of claim 6, wherein the AI application data management buffer is configured to maintain data transfer between the local memory and external memory.

8. The AI system lane of claim 1, further comprising a security policy engine coupled to the re-configurable AI compute engine, the internal memory, the common method processor, the AI application data management buffer, and the sequencer are via the inter-block AI processing chain interconnects.

9. The AI system lane of claim 8, wherein the security policy engine comprises at least one security programmable logic unit (S-PLU) configured to:
process security related features;
provide security to the AI system lane; and
enable a range of AI driven security applications.

10. A secure re-configurable AI compute engine, comprising:
a processing engine;
an AI processing controller coupled to the processing engine;
an AI solution model parameters memory coupled to the processing engine; and
an AI security parameters memory coupled to the processing engine;
wherein the processing engine comprises:
at least one AI processing logic unit (AI-PLU);
at least one security processing logic unit (S-PLU);
a local memory;
a state machine state comprising a retrieve state, a compose state, an execute state, and a transfer/write back state;
trigger in/out registers;
at least one control register;
at least one special purpose register;
at least one general purpose register; and
wherein the at least one AI-PLU, the at least one S-PLU, the state machine, the trigger in/out registers, the at least one control register, the at least one special purpose register, and the at least one general purpose register are coupled via an intra block connect bus for communication and control.

11. The secure re-configurable AI compute engine of claim 10, wherein the retrieve state of the state machine is configured to retrieve input from a local memory of an AI system lane.

12. The secure re-configurable AI compute engine of claim 10, wherein the compose state of the state machine is configured to compose an input to the at least one AI-PLU.

13. The secure re-configurable AI compute engine of claim 10, wherein the execute state of the state machine is configured to provide an execute signal to the at least one S-PLU or the at least one AI-PLU, or a combination thereof to process input data.

14. The secure re-configurable AI compute engine of claim 10, wherein the transfer/write back state of the state machine is configured to write back partial results from an output of the at least one AI-PLU or the at least one S-PLU to the general purpose register or to transfer a final output from the at least one AI-PLU or the at least one S-PLU to the local memory.

15. The secure re-configurable AI compute engine of claim 10, wherein the at least one AI-PLU comprises:
a set of multipliers;
a set of comparators; and
a set of adders;
wherein the set of multipliers, comparators, and adders are configured by the AI parameters to process AI methods based on dimensions of the AI solution model, type of AI method, and memory width; and
wherein the at least one AI-PLU is configured to process vectors at a single clock in a pipelined configuration.

16. The secure re-configurable AI compute engine of claim 15, wherein the AI methods comprise convolutional neural network (CNN) forward/backward, fully connected (FC) forward/backward, max-pooling, or un-pooling, or a combination thereof.

17. The secure re-configurable AI compute engine of claim 10, wherein the at least one AI-PLU is implemented as at least one AI-PLU instance.

18. The secure re-configurable AI compute engine of claim 17, wherein the at least one AI-PLU instance comprises a convolutional neural network (CNN) AI processing block/engine configured for forward/backward propagation.

19. The secure re-configurable AI compute engine of claim 17, wherein the at least one AI-PLU instance comprises a max-pooling AI processing block/engine configured for forward/backward propagation.

20. The secure re-configurable AI compute engine of claim 17, wherein the at least one AI-PLU instance comprises an un-pooling AI processing block/engine configured for back propagation.
